(19) United States
(12) Patent Application Publication
(10) Pub. No.: US 2024/0084707 A1
(43) Pub. Date: Mar. 14, 2024

(54) Fiber Reinforced Polymer Blade

(71) Applicant: BladeX Technologies, LLC, Palos Verdes Estates, CA (US)

(72) Inventors: Brennan Lieu, Torrance, CA (US); Aaron Guo, Palos Verdes Estates, CA (US)

(21) Appl. No.: 17/944,075

(22) Filed: Sep. 13, 2022

(51) Int. Cl. F01D 5/28; B64C 27/473; F01D 9/02; F04D 29/26

(52) U.S. Cl. CPC F01D 5/282; B64C 27/473; F01D 9/02; F04D 29/26; B64C 2027/4736; F05D 2240/12; F05D 2240/30; F05D 2300/6034

(57) ABSTRACT

A fiber-reinforced polymer blade has a blade having at least a portion of itself including a fiber-reinforced polymer, a portion of the fiber-reinforced polymer including a chopped fiber-reinforced polymer. The invention further includes methods of manufacture of the blade.

### BACKGROUND OF THE INVENTION

### Field of the Invention

This invention relates to fiber-reinforced polymer (FRP) blades, and in particular, this invention relates to FRP blades having chopped fiber-reinforced polymer and methods of manufacture thereof.

### Description of Related Art

Blades are well-known structures that typically consist of an airfoil surface and a root section that secures the blade to a rotor or stator. In this disclosure, the term “blades” refers to both blades, which are secured on rotating rotors, and vanes, which are secured on stationary stators. Generally, blades are constructed from metal, such as steel, titanium, nickel-chrome, and other alloys. The use of metals results in heavy blades that add significant static and rotational mass, and heavy vanes that add significant static mass.

Fan blades are sometimes made of fiber-reinforced polymer (FRP). FRP is a composite material having a combination of a polymer and a fiber reinforcement. Currently, FRP blades are manufactured with layers of plies impregnated with a resin in a traditional method. These blades often experience interlaminar shear due to a lack of reinforcement between layers. Traditional manufacturing of FRP blades also results in weak root sections because the laminates cannot effectively transition from the thinner airfoil section into the thicker root section. Solutions to this problem often result in laminates having to make radical bends, which causes wrinkling of the fibers and degrades structural properties of the FRP. Traditional laminate blades are also time consuming and difficult to manufacture, especially with smaller blades, such as compressor blades and turbine blades.

### SUMMARY OF THE INVENTION

The present invention teaches certain benefits in construction and use which give rise to the objectives described below.

The present invention provides a fiber-reinforced polymer blade comprising a blade having at least a portion of itself including a fiber-reinforced polymer, a portion of the fiber-reinforced polymer including a chopped fiber-reinforced polymer. The invention further includes methods of manufacture of the blade.

Blades constructed from fiber-reinforced polymer (FRP) are disclosed. FRP blades are lighter than traditional metal blades, increasing engine efficiency. FRP blades also dampen vibrations in the engine, increasing stability. A blade is manufactured out of chopped fiber-reinforced polymer with continuous wound fiber-reinforced polymer optionally added.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a schematic drawing of an isometric view of different types of fiber-reinforced polymer (FRP).

FIG. 2 is a perspective view of an example winding jig.

FIG. 3A, FIG. 3B, and FIG. 3C are conceptual schematic drawings of different stages for compression molding a chopped fiber reinforced polymer part.

FIG. 4A, FIG. 4B, and FIG. 4C are conceptual schematic drawings of different stages for resin transfer molding a chopped fiber reinforced polymer part.

FIG. 5 is a conceptual schematic drawing detailing a conceptual view of the injection molding process.

FIG. 6A, FIG. 6B, and FIG. 6C are conceptual schematic drawings of different stages for injection molding a chopped fiber reinforced polymer part.

FIG. 7A and FIG. 7B are schematic drawings of an isometric view and cross section view, respectively, of an exemplary layup jig in use.

FIG. 8A and FIG. 8B are schematic drawings of an isometric view and cross section view, respectively, of another exemplary layup jig in use.

FIG. 9 is a schematic drawing of an isometric view of the process for automated fiber placement (AFP).

FIG. 10 is a schematic drawing of a conceptual view of the pultrusion process.

FIG. 11 is a schematic drawing of an isometric view of a demonstration of roll wrapping.

FIG. 12 is a schematic drawing of an isometric view of winding filaments around a mandrel.

FIG. 13A and FIG. 13B are schematic drawings of different isometric views of a blade.

FIG. 14A is a schematic drawing of an isometric view of a blade that has a fir tree root section.

FIG. 14B is a schematic drawing of an isometric view of a blade that has a dovetail root section.

FIG. 14C is a schematic drawing of an isometric view of a blade that has a slotted platform root section.

FIG. 14D is a schematic drawing of an isometric view of a blade that has a pivoting platform root section.

FIG. 14E is a schematic drawing of an isometric view of a blade that has a bolted mount root section.

FIG. 15 is a schematic drawing of an exploded cross section view of an example gas turbine engine.

FIG. 16A, FIG. 16B, and FIG. 16C are schematic drawings of isometric, front, and cross section views, respectively, of a multi-part blade assembly.

FIG. 17A, FIG. 17B, and FIG. 17C are schematic drawings of isometric, front, and cross section views, respectively, of a multi-part blade assembly.

FIG. 18A, FIG. 18B, and FIG. 18C are schematic drawings of isometric, front, and cross section views, respectively, of a multi-part blade assembly.

FIG. 19A, FIG. 19B, and FIG. 19C are schematic drawings of isometric, front, and cross section views, respectively, of a multi-part blade assembly.

FIG. 20A, FIG. 20B, and FIG. 20C are conceptual schematic drawings of different stages of compression molding a chopped fiber reinforced polymer blade or part of a blade.

FIG. 21A, FIG. 21B, and FIG. 21C are conceptual schematic drawings of different stages of resin transfer molding a chopped fiber reinforced polymer blade or part of a blade.

FIG. 22A, FIG. 22B, and FIG. 22C are conceptual schematic drawings of different stages of injection molding a chopped fiber reinforced polymer blade or part of a blade.

FIG. 23 is a schematic drawing of an isometric view of a blade blank that is reinforced with FRP laminates that are wrapped on the blade and FRP laminates that are inserted as plates on the blade.

FIG. 24A is a conceptual schematic drawing of using filament winding and AFP on the airfoil profile of a blade blank, with the top part illustrating filament winding and the bottom part illustrating AFP.

FIG. 24B is a detail view of the bottom part of FIG. 24A.

FIG. 25A, FIG. 25B, and FIG. 25C are schematic drawings of an isometric view, a front view, and a cross section view, respectively, of a blade blank reinforced with continuous FRP tubes/rods.

FIG. 26A and FIG. 26B are schematic drawings of a front view and a cross section view, respectively, of a sheath-to-root attachment method that uses undercuts and dowel pins.

FIG. 27A and FIG. 27B are schematic drawings of a front view and a cross section view, respectively, of a sheath-to-root attachment method that uses dowel pins.

FIG. 28 is a schematic drawing of a fiber reinforced polymer blade with an elastomer layer between the main fiber reinforced polymer body and sheath on the leading edge.

FIG. 29 is a schematic drawing of a fiber reinforced polymer blade with an elastomer piece on the leading edge and an elastomer piece on the root surface.

### DETAILED DESCRIPTION OF THE INVENTION

The present application provides a new fiber reinforced polymer blade consisting partially of chopped fiber reinforced polymer.

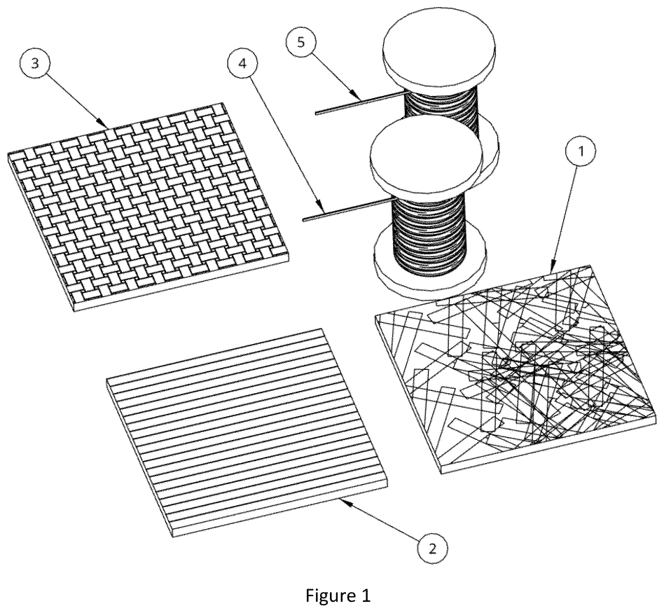

FIG. 1 is a perspective view of different types of fiber-reinforced polymer (FRP), including chopped FRP in chopped fiber molding compound form as an SMC (1), FRP fabric in unidirectional form (2), FRP fabric in plain weave woven form (3), FRP dry tow (4), and FRP towpreg (5).

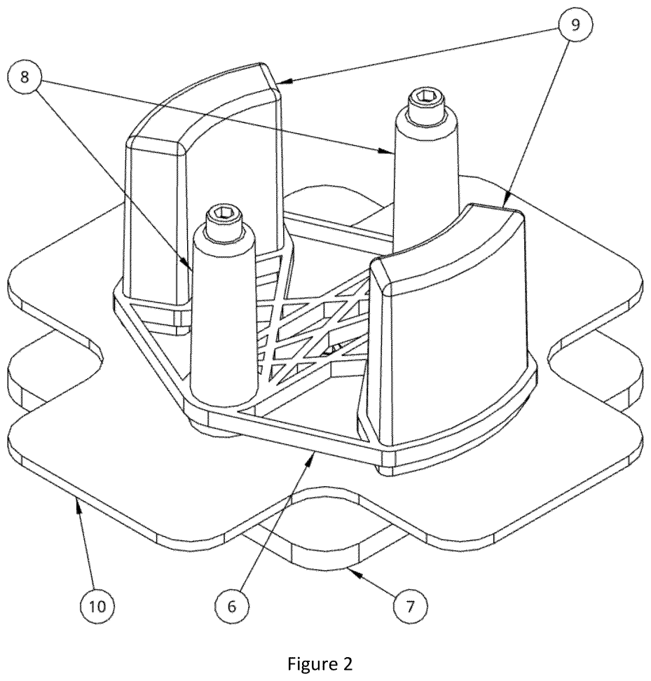

FIG. 2 is a schematic drawing of an isometric view of an example winding jig, including: the winding (6), the winding jig base (7), winding jig protrusions that are attached to the base (8), winding jig protrusions that are the same piece as the base (9), and the ejector plate (10).

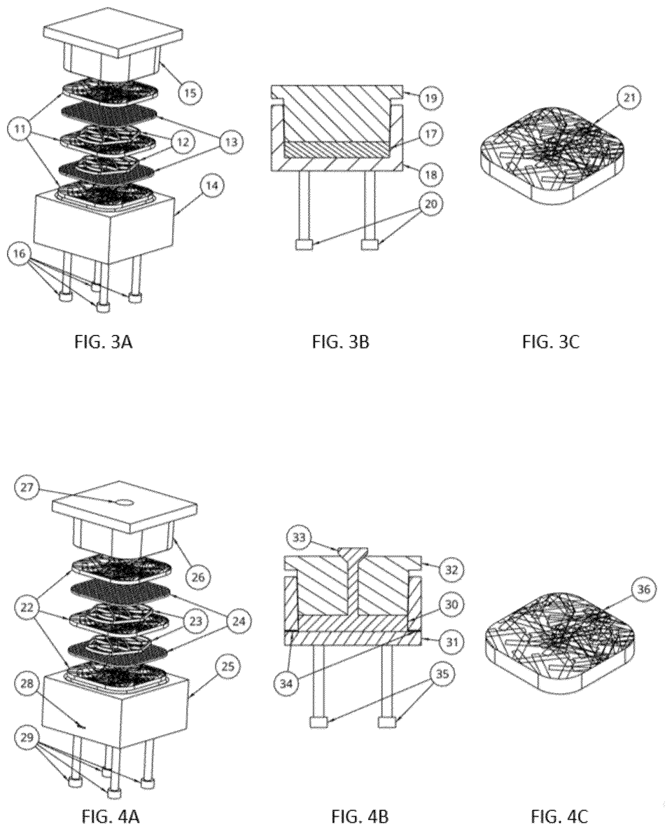

FIG. 3A, FIG. 3B, and FIG. 3C are conceptual schematic drawings of different stages for compression molding a chopped fiber reinforced polymer part. The first stage shown as FIG. 3A is an isometric view of a conceptual, expanded pre-molding setup for compression molding, including: the chopped fiber molding compound material (11), the windings (12), the fabric fiber laminates (13), the cavity (14), the core (15), and the ejector pins (16). The second stage shown as FIG. 3B is a cross section view of the conceptual compression molding process, including: the part being molded (17), the cavity (18), the core (19), and the ejector pins (20). The third stage shown as FIG. 3C is an isometric view of the final molded part (21). FIG. 3A and FIG. 3B are for illustrative purposes only and do not contain all the parts and features that typically exist in a functioning mold. FIG. 3A and FIG. 3B show the main areas that interact with the molded part.

FIG. 4A, FIG. 4B, and FIG. 4C are conceptual schematic drawings of different stages for resin transfer molding a chopped fiber reinforced polymer part. The first stage shown as FIG. 4A is an isometric view of a conceptual, expanded pre-molding setup for resin transfer molding, including: the chopped fiber material (22), the windings (23), the fabric fiber (24), the cavity (25), the core (26), the resin injector (27), the vents (28), and the ejector pins (29). The second stage shown as FIG. 4B is a cross section view of the conceptual compression molding process, including: the part being molded (30), the cavity (31), the core (32), the resin injector (33), the vents (34), and the ejector pins (35). The third stage shown as FIG. 4C is an isometric view of the final molded part (36). FIG. 4A and FIG. 4B are for illustrative purposes only and do not contain all the parts and features that typically exist in a functioning mold. FIG. 4A and FIG. 4B show the main areas that interact with the molded part.

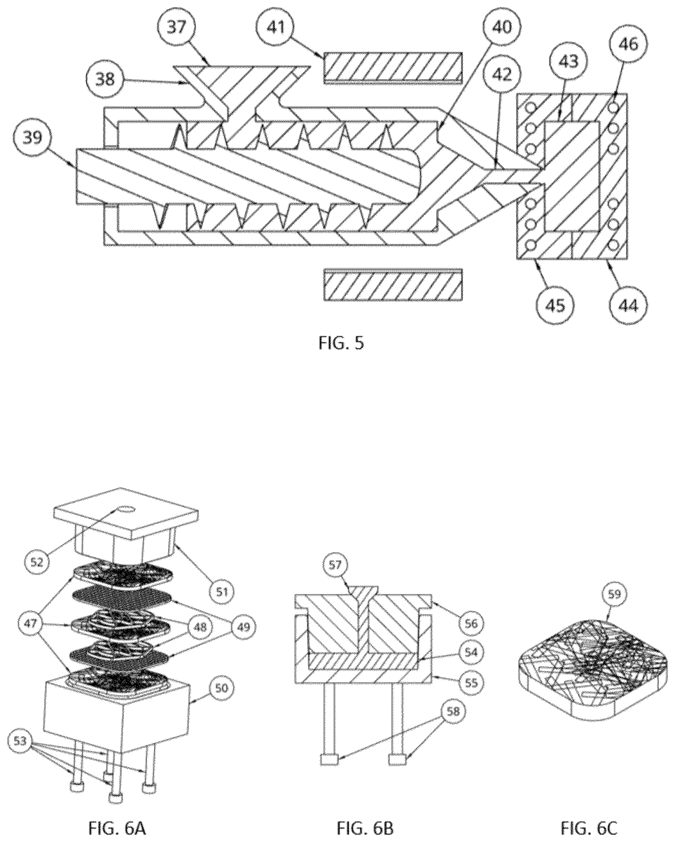

FIG. 5 is a conceptual schematic drawing detailing a conceptual view of the injection molding process, including: plastic pellets (37), a hopper (38), an injection ram (39), the pellets being pushed and heated (40), a heater (41), the sprue (42), the part being molded (43), the cavity (44), the core (45), and cooling ports (46).

FIG. 6A, FIG. 6B, and FIG. 6C are conceptual schematic drawings of different stages for injection molding a chopped fiber reinforced polymer part. The first stage shown as FIG. 6A is an isometric view of a conceptual, expanded pre-molding setup for injection molding, including: inserted chopped fiber material (47), inserted windings (48), inserted fabric fiber (49), the cavity (50), the core (51), the sprue (52), and the ejector pins (53). The second stage shown as FIG. 6B is a cross section view of a conceptual injection molding process, including: the part being molded (54), the cavity (55), the core (56), the sprue (57), and the ejector pins (58). The third stage shown as FIG. 6C is an isometric view of the final molded part (59). FIG. 6A and FIG. 6B are for illustrative purposes only and do not contain all the parts and features that typically exist in a functioning mold. FIG. 6A and FIG. 6B show the main areas that interact with the molded part.

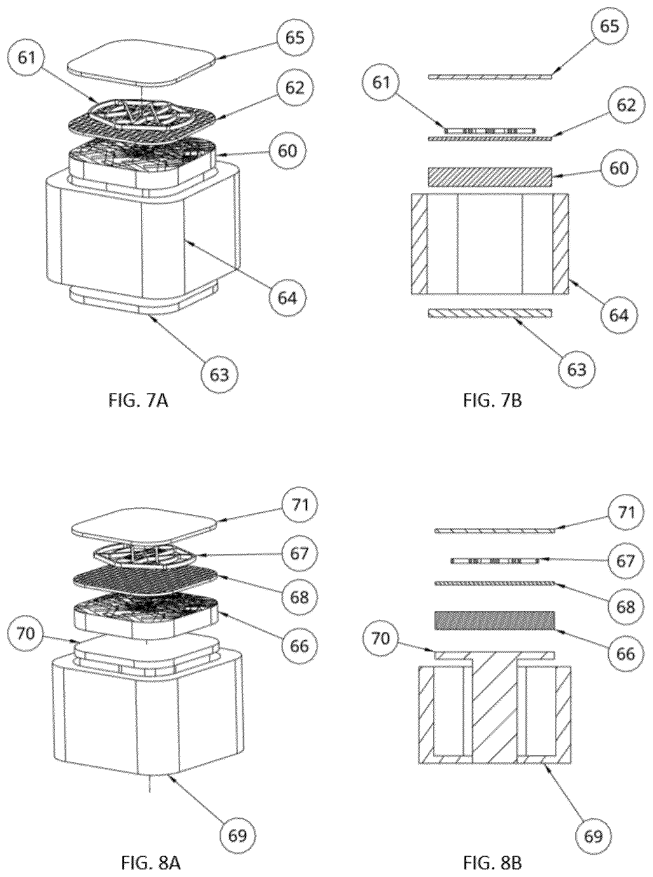

FIG. 7A and FIG. 7B are schematic drawings of an isometric view and cross section view, respectively, of an exemplary layup jig in use, including: the chopped fiber material (60), the windings (61), the fabric laminates (62), the base (63), the removable cavity wall (64), and the compressor plate (65).

FIG. 8A and FIG. 8B are schematic drawings of an isometric view and cross section view, respectively, of another exemplary layup jig in use, including: the chopped fiber material (66), the windings (67), the fabric laminates (68), the base (69), the ejector plate (70), and the compressor plate (71).

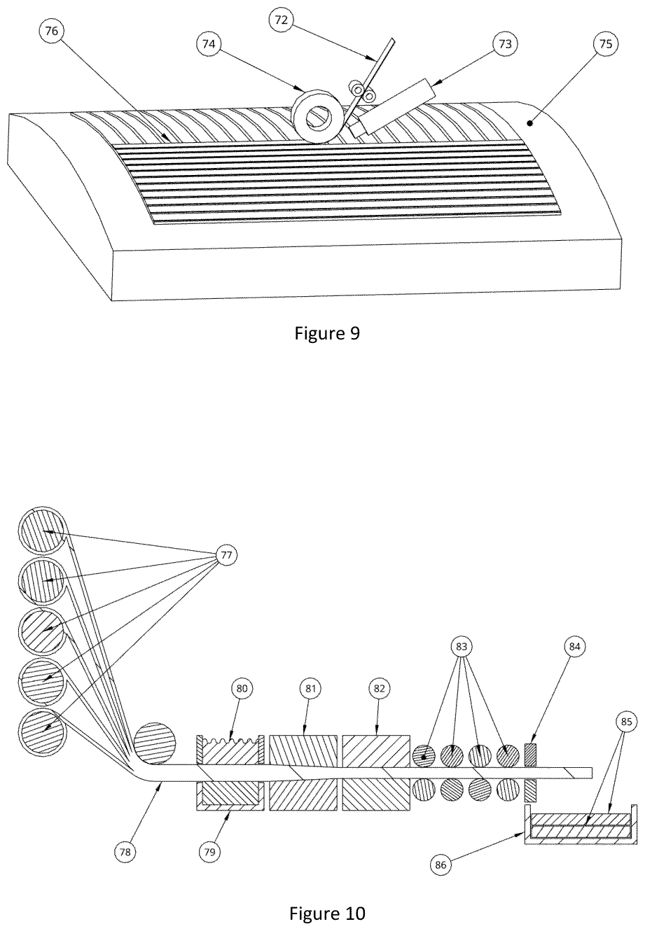

FIG. 9 is a schematic drawing of an isometric view of the process for automated fiber placement (AFP), including: the fiber tow (72), the heating source (73), the consolidation roller (74), the mold surface (75), and the part being molded (76).

FIG. 10 is a schematic drawing of a conceptual view of the pultrusion process, including: rovings of fiber (77), consolidation of the tows of fiber (78), a resin impregnation station (79), the resin (80), a heated die (81), a cooling die (82), pullers (83), a cutoff station (84), cut off fiber reinforced polymer parts (85), and a catching station (86).

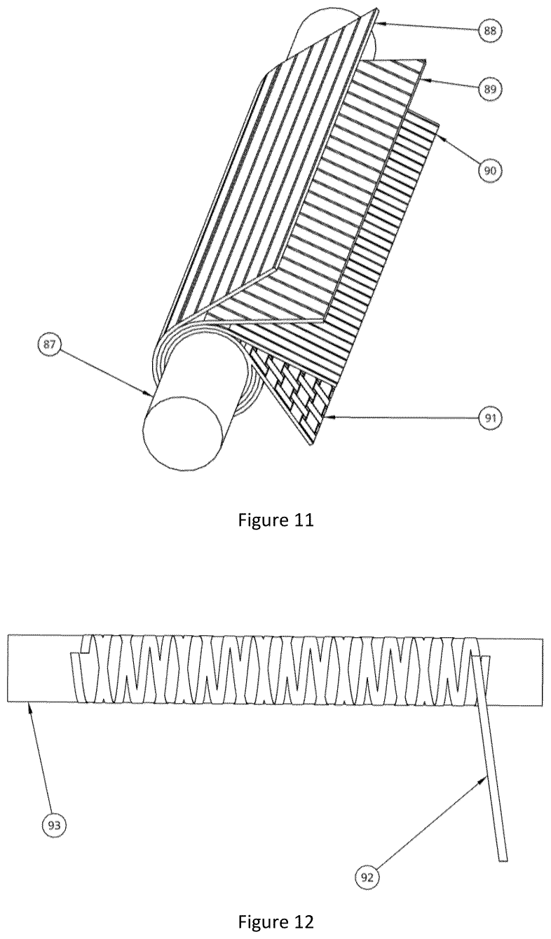

FIG. 11 is a schematic drawing of an isometric view of a demonstration of roll wrapping including: a mandrel (87), a zero-degree laminate being wrapped around the mandrel (88), a 45-degree laminate being wrapped around the mandrel (89), a 90-degree laminate being wrapped around the mandrel (90), and a woven laminate being wrapped around the mandrel (91).

FIG. 12 is a schematic drawing of an isometric view of winding filaments (92) around a mandrel (93).

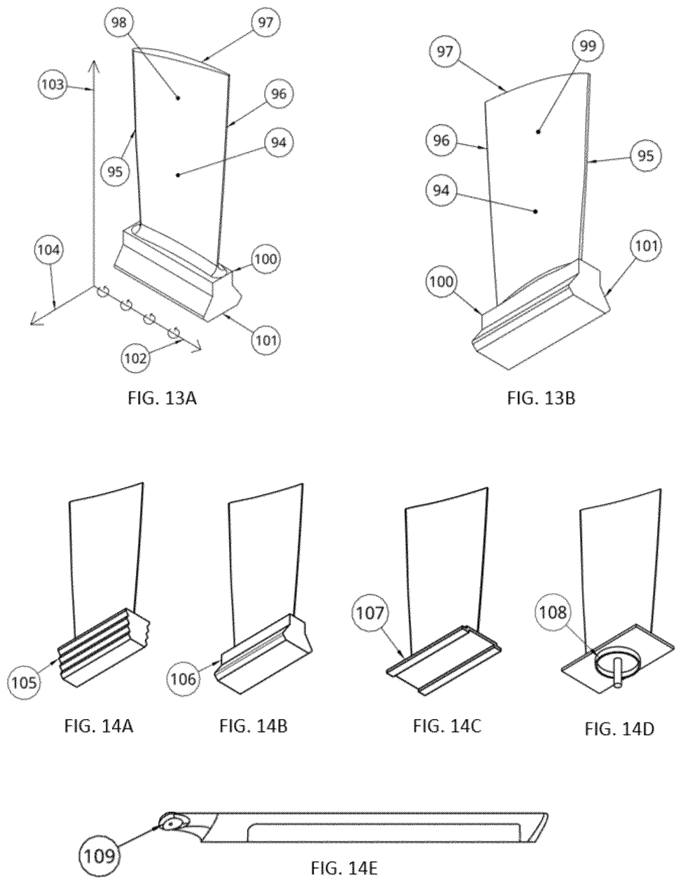

FIG. 13A and FIG. 13B are schematic drawings of different isometric views of a blade, including: the entire airfoil profile (94), the leading edge (95), the trailing edge (96), the squealer tip (97), the pressure side (98), the suction side (99), the platform (100), the root section (101), the axial direction (102), the radial direction (103), and the circumferential direction (104).

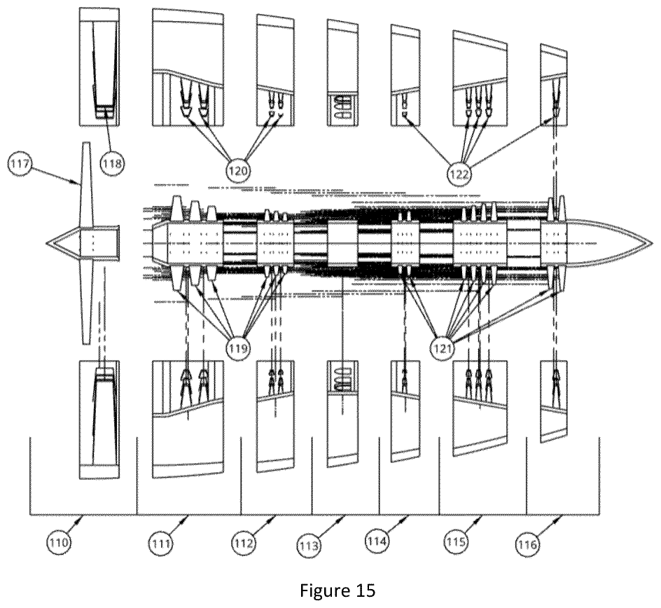

FIG. 14A is a schematic drawing of an isometric view of a blade that has a fir tree (105) root section.

FIG. 14B is a schematic drawing of an isometric view of a blade that has a dovetail (106) root section.

FIG. 14C is a schematic drawing of an isometric view of a blade that has a slotted platform (107) root section.

FIG. 14D is a schematic drawing of an isometric view of a blade that has a pivoting platform (108) root section.

FIG. 14E is a schematic drawing of an isometric view of a blade that has a bolted mount (109) root section.

FIG. 15 is a schematic drawing of an exploded cross section view of an example gas turbine engine, including: the fan section (110), the low-pressure/intermediate-pressure (LP/IP) compressor section (111), the high-pressure (HP) compressor section (112), the combustor section (113), the HP turbine section (114), the IP turbine section (115), the LP turbine section (116), the fan blades (117), the variable guide vanes (118), the compressor rotor blades (119), the compressor stator vanes (120), the turbine rotor blades (121), and the turbine stator vanes (122).

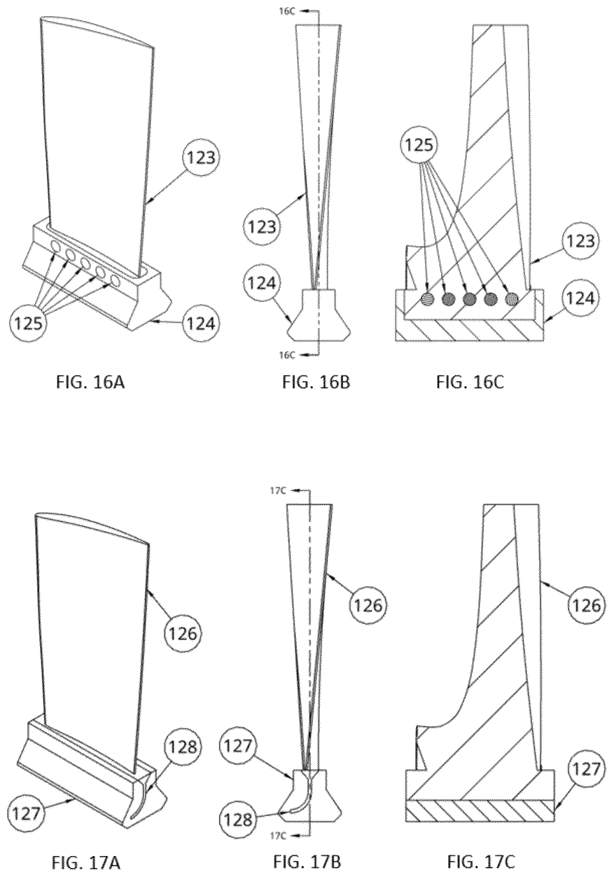

FIG. 16A, FIG. 16B, and FIG. 16C are schematic drawings of isometric, front, and cross section views, respectively, of a multi-part blade assembly. Said assembly includes an airfoil (123) that slides radially into the root (124) and is secured with dowel pins (125).

FIG. 17A, FIG. 17B, and FIG. 17C are schematic drawings of isometric, front, and cross section views, respectively, of a multi-part blade assembly. Said assembly includes an airfoil (126) that slides axially into the root (127) with a bend-type undercut (128).

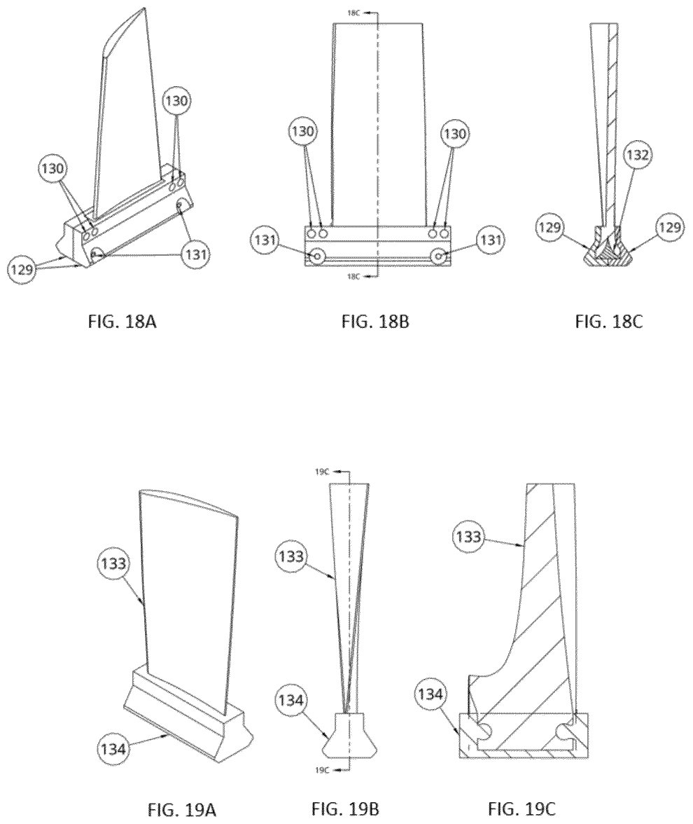

FIG. 18A, FIG. 18B, and FIG. 18C are schematic drawings of isometric, front, and cross section views, respectively, of a multi-part blade assembly. Said assembly includes a split root pair (129) with dowel pins (130) between the root pair, fasteners (131) between the root pair, and an undercut with a wedge (132).

FIG. 19A, FIG. 19B, and FIG. 19C are schematic drawings of isometric, front, and cross section views, respectively, of a multi-part blade assembly. Said assembly includes an initial airfoil part (133) that has its root (134) molded around it.

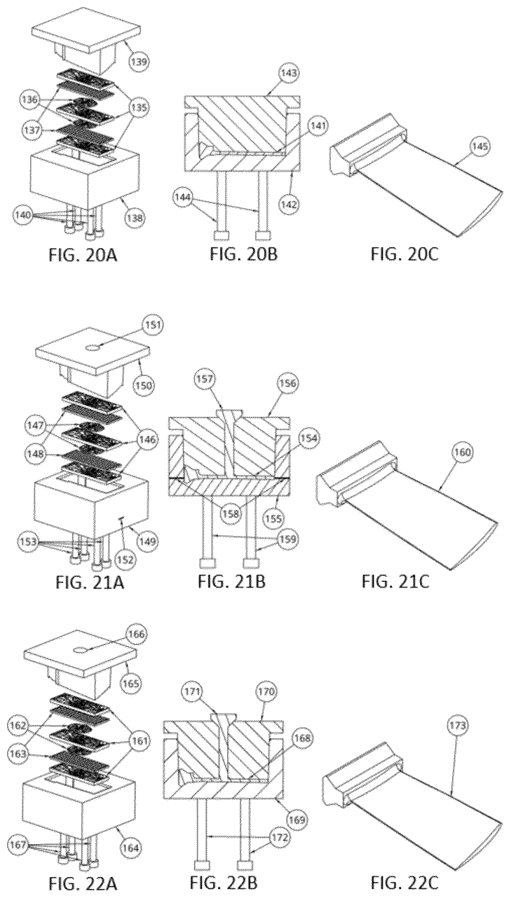

FIG. 20A, FIG. 20B, and FIG. 20C are conceptual schematic drawings of different stages of compression molding a chopped fiber reinforced polymer blade or part of a blade. The first stage shown as FIG. 20A is an isometric view of a conceptual, expanded pre-molding setup for compression molding, including: the chopped fiber molding compound material (135), the windings (136), the fabric fiber laminates (137), the cavity (138), the core (139), and the ejector pins (140). The second stage shown as FIG. 20B is a cross section view of the conceptual compression molding process, including: the part being molded (141), the cavity (142), the core (143), and the ejector pins (144). The third stage shown as FIG. 20C is an isometric view of the final molded part (145). FIG. 20A and FIG. 20B are for illustrative purposes only and do not contain all the parts and features that typically exist in a functioning mold. FIG. 20A and FIG. 20B show the main areas that interact with the molded part.

FIG. 21A, FIG. 21B, and FIG. 21C are conceptual schematic drawings of different stages of resin transfer molding a chopped fiber reinforced polymer blade or part of a blade. The first stage shown as FIG. 21A is an isometric view of a conceptual, expanded pre-molding setup for compression molding, including: the chopped fiber material (146), the windings (147), the fabric fiber (148), the cavity (149), the core (150), the resin injector (151), the vents (152), and the ejector pins (153). The second stage shown as FIG. 21B is a cross section view of the conceptual resin transfer molding process, including: the part being molded (154), the cavity (155), the core (156), the resin injector (157), the vents (158), and the ejector pins (159). The third stage shown as FIG. 21C is an isometric view of the final molded part (160). FIG. 21A and FIG. 21B are for illustrative purposes only and do not contain all the parts and features that typically exist in a functioning mold. FIG. 21A and FIG. 21B show the main areas that interact with the molded part.

FIG. 22A, FIG. 22B, and FIG. 22C are conceptual schematic drawings of different stages of injection molding a chopped fiber reinforced polymer blade or part of a blade. The first stage shown as FIG. 22A is an isometric view of a conceptual, expanded pre-molding setup for injection molding, including: inserted chopped fiber material (161), inserted windings (162), inserted fabric fiber (163), the cavity (164), the core (165), the sprue (166), and the ejector pins (167). The second stage shown as FIG. 22B is a cross section view of the conceptual injection molding process, including: the part being molded (168), the cavity (169), the core (170), the sprue (171), and the ejector pins (172). The third stage shown as FIG. 22C is an isometric view of the final molded part (173). FIG. 22A and FIG. 22B are for illustrative purposes only and do not contain all the parts and features that typically exist in a functioning mold. FIG. 22A and FIG. 22B show the main areas that interact with the molded part.

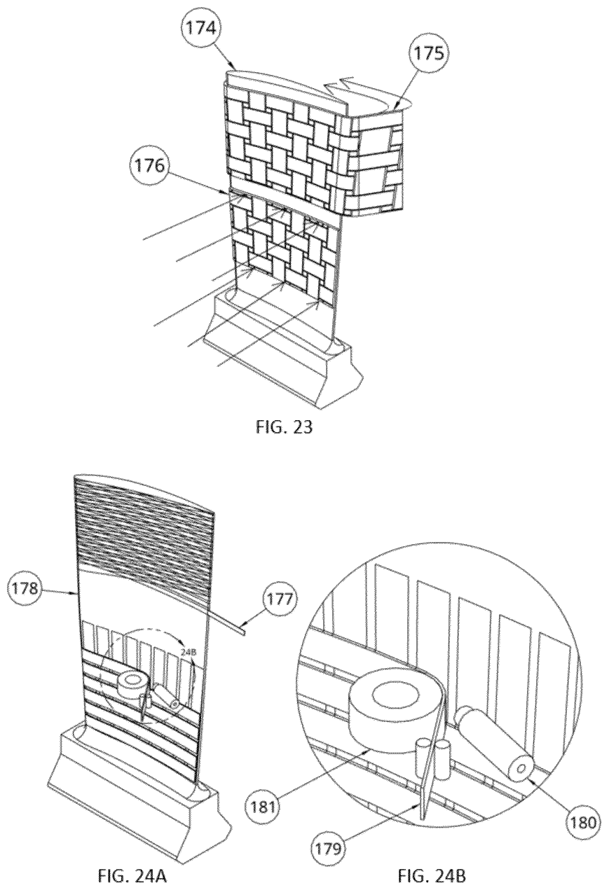

FIG. 23 is a schematic drawing of an isometric view of a blade blank (174) that is reinforced with FRP laminates that are wrapped on the blade (175) and FRP laminates that are inserted as plates on the blade (176).

FIG. 24A is a conceptual schematic drawing of using filament winding and AFP on the airfoil profile of a blade blank. FIG. 24B is a detail view of the bottom part of FIG. 24A. On FIG. 24A, the top part illustrates a conceptual view of filament winding tows (177) around the airfoil profile of a blade blank (178). The bottom part illustrates a conceptual view of using AFP on the airfoil profile (178), including: the tow (179), the heating source (180), and the consolidation roller (181).

FIG. 25A, FIG. 25B, and FIG. 25C are schematic drawings of an isometric view, a front view, and a cross section view, respectively, of a blade blank (182) reinforced with continuous FRP tubes/rods, including: a tube inserted in a primary axial direction (183) and a rod inserted in a primary radial direction (184).

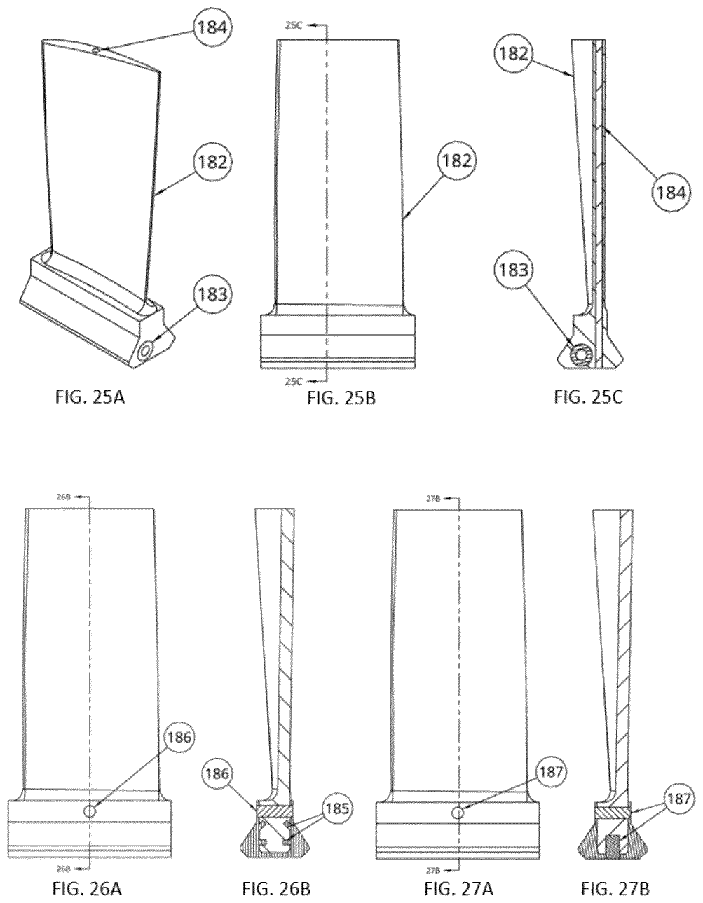

FIG. 26A and FIG. 26B are schematic drawings of a front view and a cross section view, respectively, of a sheath-to-root attachment method that uses undercuts (185) and dowel pins (186).

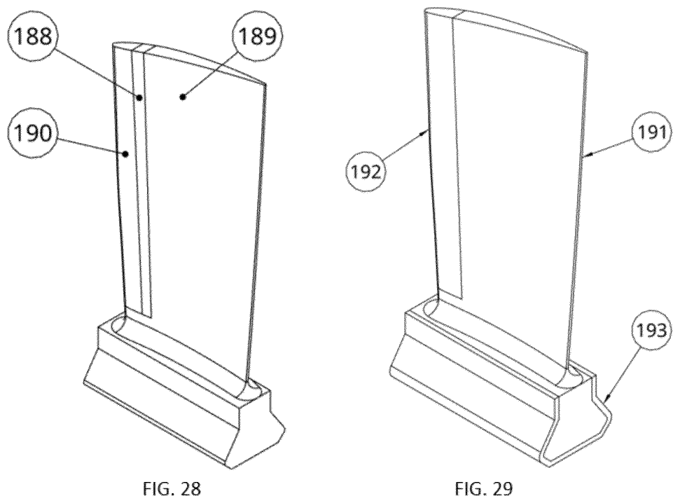

FIG. 27A and FIG. 27B are schematic drawings of a front view and a cross section view, respectively, of a sheath-to-root attachment method that uses dowel pins (187).

FIG. 28 is a schematic drawing of a fiber reinforced polymer blade with an elastomer layer (188) between the main fiber reinforced polymer body (189) and sheath (190) on the leading edge.

FIG. 29 is a schematic drawing of a fiber reinforced polymer blade (191) with an elastomer piece on the leading edge (192) and an elastomer piece on the root surface (193).

### Material Definitions

Technical Ceramics: Technical ceramics are commonly considered advanced ceramics or engineered ceramics. Technical ceramics have desirable mechanical, thermal, and/or electrical properties. They are typically oxides, carbides, borides, nitrides, or silicides. Technical ceramics typically exhibit high hardness and substantially high compressive strengths. However, technical ceramics tend to be brittle and have substantially low tensile/shear strengths. A non-exhaustive list of examples of technical ceramics: Al2O3 (Aluminum Oxide), SiC (Silicon Carbide), WC (Tungsten Carbide), Shapal (a hybrid aluminum nitride ceramic), Macor (a machinable glass-ceramic), BN (Boron Nitride), AlN (Aluminum Nitride), B4C (Boron Carbide), Si3N4 (Silicon Nitride), ZrO2 (Zirconium Oxide), TiN (Titanium Nitride), ZrN (Zirconium Nitride), CrN (Chromium Nitride), TiCN (Titanium Carbonotride), CrCN (Chromium Carbonotride), TiCrN (Titanium Chromium Nitride), AlTiN (Aluminum Titanium Nitride), and AlCrN (Aluminum Chromium Nitride).

Elastomer: Elastomers are polymers that are very elastic, meaning that they have a high failure strain rate (essentially, they can stretch a lot). They generally have a low Young's modulus (or stiffness). Common examples are rubber and silicone. A non-exhaustive list of elastomers: natural rubber, isoprene rubber, butadiene rubber, silicone rubber, fluorosilicone rubber, fluoroelastomers, Ethylene-vinyl acetate.

Thermosets: Thermosets are polymers which are permanently cured by thermal or chemical activation. A non-exhaustive list of thermosets: polyester, epoxy, phenolic, vinyl ester, bismaleimide, polyurea, polyurethane, silicone, fluoropolymer, polyamide, and polyamide-imide (polyamide-imides are thermoplastic or thermoset depending on the specific material).

Thermoplastics: Thermoplastics are polymers which are capable of being remelted and recast after being cooled. A non-exhaustive list of thermoplastics: polytetrafluoroethylene, polyvinylidene fluoride, polycarbonate, polyoxymethylene, nylon, polyamide-imide (polyamide-imides are thermoplastic or thermoset depending on the specific material), and polyether ether ketone.

Organic Polymers: Organic polymers are polymers that include carbon atoms in their backbone. Most common polymers, such as epoxies and polycarbonate, are organic polymers. Organic polymers typically cannot withstand temperatures higher than 1000 F. A non-exhaustive list of examples of organic polymers: epoxy, polycarbonate, polyether ether ketone, polyimide, and natural rubber. Hybrid polymers consist of polymers that have inorganic and organic components, and for the simplicity of this application, are considered organic polymers.

Inorganic Polymers: Inorganic polymers are polymers that do not use carbon atoms in their backbone. Inorganic polymers are commonly used due to their ability to withstand higher temperatures than organic polymers. In addition, inorganic polymers can often be thermally converted to ceramics after curing, further increasing temperature resistance. An example of these materials is Pyromeral System's PyroSic and PyroKarb. PyroSic and PyroKarb are material systems based on a glass-ceramic matrix material and can withstand much higher temperatures than organic polymers. A non-exhaustive list of examples of inorganic polymers: silicone, geopolymers, and polysiloxanes. A tradeoff with inorganic polymers is that in return for their high temperature performance, they are typically much more expensive and brittle than organic polymers.

Fiber-Reinforced Polymer (FRP): FRP is a composite material that consists of fibers embedded within a polymer matrix material. The polymer matrix material is also considered the resin of the FRP. The polymer could be an organic polymer or inorganic polymer and take the form of a thermoset or thermoplastic. These materials generally have a substantially high strength-to-weight ratio and stiffness-to-weight ratio. Common examples of fiber reinforcements include but are not limited to carbon, boron, silica, quartz, fiberglass, aramid, Kevlar, UHMWPE, Dyneema, and basalt. When referring to the strength of Fiber-Reinforced Polymer materials, oftentimes mechanical properties are considered in the unidirectional (UD) orientation of the FRP. This would be when all the fibers align in the direction the material is being stressed in in, which is typically where the highest tensile, compressive, and flexural strengths are achievable.

Glass Transition Temperature (Tg): The Tg of an FRP is the temperature at which the polymer matrix of an FRP starts to turn rubbery. The Tg of an FRP is often used to evaluate its service temperature, as once the Tg is exceeded, the polymer matrix of an FRP starts to break down and the mechanical properties of the FRP decrease severely.

Chopped FRP: Chopped FRPs are FRPs that consist of fibers that are cut. Typically, the fibers are in a random orientation, and the average length of the chopped fibers in a chopped FRP is considered the average fiber length (AFL) of a chopped FRP.

Chopped fiber molding compound (CFMC): CFMCs are chopped FRP materials that have been impregnated with an uncured resin. They are then molded into parts. They typically come in the form of a BMC (bulk molding compound), SMC (sheet molding compound), TMC (thick molding compound), or fiber filled polymer. BMCs consist of uncured FRP tows that are cut and come in a bulk form. SMCs (1) are like BMCs, but are consolidated into a sheet, as can be seen in FIG. 1. TMCs are like SMCs, except that the term TMC is used when the sheet is relatively thick (typically around 2″ or thicker). Fiber filled polymers consist of polymers that are reinforced with very short fibers. The fibers in fiber filled polymers are often milled and can have an AFL of less than 0.001″.

FRP fabric: FRP fabric refers to laminates of FRP where the fibers are continuous. Unidirectional (UD) FRP fabrics (2) have all their fibers oriented in the same direction. UD FRP fabrics can sometimes be called FRP tape, or unitapes. Unitapes typically are very long in their fiber direction and can be rolled up on a creel. FRP fabrics can also be woven, as can be seen in the biaxial plain weave FRP fabric (3) of FIG. 1. Although not illustrated in FIG. 1, there are many other types of fabric weaves, such as twill-weaves, satin-weaves, etc. and they can have more fiber orientations by being a triaxial or quad axial weave.

FRP dry tow: FRP dry tow (4) consists of material that comes in the form of a single tow of dry fiber. It is dry, meaning that it is not impregnated with resin yet. The dry tow typically is wound on a creel, as can be seen in FIG. 1.

FRP towpreg: FRP towpreg (5), or prepreg tow, consists of material that comes in the form of a single impregnated tow of fiber. Similar to dry tow, it is typically wound on a creel. Oftentimes, FRP towpreg is created from FRP dry tow by impregnating the dry tow with resin.

Continuous Wound FRP: Continuous wound FRP is also referred to as windings in this application. Windings are made from dry tow or towpreg that is wound into different shapes. As seen in FIG. 2, the winding (6) can be wound on a winding jig. The winding jig base (7) has protrusions that are attached to the base (8) and/or winding jig protrusions that are the same piece as the base (9). These winding jig protrusions that are the same piece as the base (9) are generally machined into the base (7) as one part. The winding (6) is wound on these different winding jig protrusions in any order, and in any thickness as seen necessary by the manufacturer. After the continuous wound FRP (6) is made on the winding jig, an ejector plate (10) is used to push the winding off the winding jig. Continuous wound FRP is often molded with other materials (which is described in later definitions).

Adhesive: In this application, the term adhesive encompasses any substance used for bonding objects together. This includes all thermoset adhesives or thermoplastic adhesives, which are described below.

Thermoset Adhesives: Thermoset adhesives are adhesives made from thermoset resin. These adhesives are supplied in a pre-cured state, applied to the workpiece for bonding, and cured. Some adhesives cure chemically, in which exposure to air or a chemical reactor (in which the adhesive would normally consist of two components that are mixed before being applied) causes curing. Some adhesives cure thermally, in which heat is used to cure the adhesive. Common examples of thermosetting adhesives are JB Weld and Loctite.

Thermoplastic Adhesives: Thermoplastic Adhesives are adhesives made from a thermoplastic resin. Thermoplastic adhesives typically consist of resins that are preheated to near or above their melting temperature before they are applied to the workpiece. The workpiece is bonded, and the resin is then allowed to cool and harden. Thermoplastic adhesives are commonly based on Ethylene Vinyl Acetate (EVA).

### FRP Manufacturing Process Definitions:

Post Curing: Post curing can occur after any of the processes described below. It consists of exposing a part to high temperatures for an extended period. The post cure temperature is typically higher than curing temperatures. The post cure process typically increases the brittleness of FRP materials, but in return increases the Tg of the resin in FRP materials. When done at very high temperatures and for a long time, post curing can also thermally convert certain polymers into ceramic materials for even higher temperature performance.

Compression Molding: Compression Molding is a process used to produce parts, in which FRP material is placed into a mold and compressed under pressure with a press. After a set amount of time, the pressure is released, the mold is opened, and the part is ejected. Typically, CFMCs are used with compression molding, and continuous wound FRP and/or FRP fabrics can be added to increase the strength and stiffness of the part being molded. This process can be seen in FIG. 3A, FIG. 3B, and FIG. 3C. In the conceptual pre-molding setup, CFMC material (11), windings (12), and FRP fabrics laminates (13) are inserted into the cavity (14) to be compressed by the core (15). Ejector pins (16) are all the way down to sit with the cavity. Then, the mold is compressed, and the part being molded (17) is compressed between the cavity (18) and core (19). Then, the mold opens, and the ejector pins (20) are used to eject the final molded part (21) out of the cavity (18). If the FRP material being compression molding is thermoset based, the material is optionally preheated before molding and the temperature of the mold must be hot enough to cure the material. However, if the material is thermoplastic based, it must be preheated to a temperature above its glass transition temperature (Tg) to allow the material to soften enough for molding. The mold temperature is optimally set below the melting temperature (Tm) of the material such that the part is ejected quickly. However, for thermoplastic compression molding, the mold temperature sometimes must be set above Tm for the material to adequately fill the mold cavity. For thermoplastic compression molding, the mold must be cooled to a temperature less than Tm before ejection, thereby adding cycle time and costs.

Resin Transfer Molding (RTM): RTM is a process in which dry fibers are placed into a mold, and in the case of a thermoset resin, the mold is then filled with resin and heated to cure the resin. For thermoplastics, the resin would be pre-heated, and the mold would cool the resin to solidify it. In this application, the term RTM encompasses the conventional RTM process, the HPRTM process, and the VARTM process. Conventional RTM typically occurs at pressures less than 40 bar. High Pressure Resin Transfer Molding (HPRTM) uses pressures of up to 200 bar during the molding process to greatly increase efficiency with cycle times as short as a few minutes for smaller parts. Further, during the HPRTM process, the mold is typically a closed mold which is not fully compressed when the resin is injected thereby allowing excess resin to flow in the mold. The mold is then compressed with a press to squeeze out the excess resin, allowing for higher molding efficiencies, higher fiber-to-resin ratios, and better mechanical properties compared to conventional RTM. In Vacuum Assisted Resin Transfer Molding (VARTM), the resin flow is assisted by a vacuum. An advantage of VARTM is having cheaper equipment costs and high fiber-to-resin ratios compared to conventional RTM.

The RTM process can use chopped fiber material, with the addition of windings and/or fabric fiber to increase the stiffness and strength of the molded part. The process can be seen in FIG. 4A, FIG. 4B, and FIG. 4C. In the conceptual pre-molding setup, chopped fiber material (22), windings (23), and fabric fiber (24) are inserted into the cavity (25). The chopped fiber material (22), windings (23), and fabric fiber (24) can be inserted dry or pre-impregnated, depending on manufacturing preference for them to be pre-impregnated or get impregnated by the RTM resin. Then, the mold is compressed, and the resin injector (33) injects resin through the core (32) to the part being molded (30). Vents (34) are used for excess resin to flow. Then, the mold opens, and the ejector pins (35) are used to eject the final molded part (36) out of the cavity (31).

Injection Molding: Injection molding is a process used to produce molded products, in which plastic material is injected into a mold, solidified, and ejected. The process of injection molding thermoplastic materials is illustrated in FIG. 5. Pellets of plastic material (37) are inserted into a hopper (38). An injection ram (39), which generally has the shape of a screw, turns to push the plastic forward. The plastic being pushed forward (40) is heated by heaters (41) and pushed through the sprue (42), which is a narrow opening for the plastic to flow through. The plastic is molded into the shape of the molded part (43) by being injected into the cavity (44) and the core (45). In thermoplastic injection molding, cooling ports (46) which typically run water are present to solidify the part. The cavity (44) and core (45) are then separated, and the part is ejected. In thermoset injection molding, there are no heaters (41), and the plastic material (37) is inserted cold, into the heated cavity (44) and core (45). Further, instead of cooling ports (46), thermoset injection molding includes heaters. The heaters in the cavity (44) and core (45) of the mold cure the thermoset material coming from the sprue (42) and solidify the part before ejection. The thermoset or thermoplastic material being injected is generally an unreinforced polymer. Pellets with fiber filled polymers are used to injection mold FRP material. However, it is generally difficult to achieve long fiber lengths because the fibers break in the process of getting pushed by the injection ram (39) and through the sprue (42).

The injection molding process can use the addition of fiber reinforcement materials. Chopped fiber material, windings, and/or fabric can all be inserted into the mold before material is injected. When these materials are inserted into the mold before injection, they do not need to go through the injection ram or sprue, so the fibers can be continuous or in the case of chopped fiber, much longer. The process can be seen in FIG. 6A, FIG. 6B, and FIG. 6C. In the conceptual pre-molding setup, chopped fiber material (47), windings (48), and fabric fiber (49) are inserted into the cavity (50). The chopped fiber material (47), windings (48), and fabric fiber (49) can be inserted dry or impregnated, depending on manufacturing preference for them to be pre-impregnated or get impregnated by the polymer being injected. Then, the mold is compressed, and resin is injected through the sprue (57) to the part being molded (54). Then, the mold opens, and the ejector pins (58) are used to eject the final molded part (59) out of the cavity (55).

Layup Jigs: Layup jigs can be used with compression molding, RTM, and injection molding. For example, layup jigs are illustrated in FIG. 7A, FIG. 7B, FIG. 8A, and FIG. 8B. The layup jig holds the chopped fiber material (60 and 66), the windings (61 and 67), and/or the fabric laminates (62 and 68) together for preheating. With both thermosets and thermoplastic based materials, preheating the material to be molded together helps to create a stronger part, while also reducing cycle time. This reduction in cycle time in turn reduces manufacturing costs. If the material is thermoplastic based, although optional, it is highly recommended to use a layup jig. Without preheating, the thermoplastic material is hard, and the mold will have to first be heated and then cooled to create the molded part. For thermoset materials, it is recommended to use a layup jig, however it is not necessary because thermoset molding material is generally sufficiently soft to be molded while uncured. In addition, thermoset material cannot be preheated for too long, as doing so causes the molding material to cure within the layup jig.

If using a layup jig, after all the molding material is preheated together, it is inserted into the cavity of the mold. To make the material easily transferable to the mold, the layup jig must either allow easy access to the molding material or have an ejector system. The layup jig illustrated in FIG. 7A and FIG. 7B allows for easy access to the molding material, because a base (63) lies within a removable cavity wall (64). The removable cavity wall (64) is pulled up, exposing the molding material. The layup jig in FIG. 8A and FIG. 8B uses an ejector system with the presence of a base (69) and an ejector plate (70). The base (69) and the ejector plate (70) are placed upside down on top of the mold, and the ejector plate (70) is pressed down to push the molding material into the cavity of the mold. In addition, a compressor plate (65 and 71) is often used to pre-compress the material before it is inserted into the mold. Hand pressure or a press can be used to push the compressor plate (65 and 71) onto the material. This compaction can improve the mechanical properties of the final part and make manufacturing more efficient by making it easier to load the mold.

Vacuum Bagging: This is a method of creating FRP parts in which the material is placed on a mold tool, covered with a ply (which is used to improve the surface finish), and covered with a breather fabric which absorbs extra resin. The system is then placed in a vacuum bag, which is used to remove the air and mold the part. Vacuum bagging removes excess air and humidity during the curing process thereby allowing a high fiber-to-resin ratio, increasing the mechanical properties, and decreasing the impurities of the FRP part. In addition, the process of vacuum bagging typically utilizes very low setup and tooling costs.

Hand Laying Up: This is a method of creating FRP parts in which fibers, that are unidirectional, woven, knitted, stitched, chopped, or bonded, are placed in a mold, and reinforced with resin by a brush. Among the various methods described herein, this process typically has the lowest setup and tooling costs. However, the process is very labor intensive and often produces parts that have a lot of impurities and need to be scrapped.

Autoclave Manufacturing: This is a method of creating FRP parts in which laminates of FRP are placed in a mold and spot-welded together, then vacuum bagged and placed in an autoclave. The laminates are then subjected to high pressure and temperatures to cure.

Automated Fiber Placement (AFP): This is a process that heats and compacts FRP towpreg on a mold surface to create parts. Multiple layers of towpreg are often applied on top of each other to create the thickness necessary for the final part. This process can be seen in FIG. 9. Towpreg (72) is fed through the machine. It is then heated with a preheating source (73) and compacted with a consolidation roller (74). This process creates an FRP part (76) on the surface of a mold (75). This process is often highly automated and allows for precisely engineered fiber orientation on the final part being molded. This process is commonly used to create a composite part with a reusable mold. However, in some embodiments, other FRP structures act as the “mold” and the towpreg layers being placed act as additional support, strength, and permanent reinforcements to the FRP structure. Automated Tape Placement (ATP) is like AFP, except that typically the process is considered ATP instead of AFP when the material being placed is wide enough to be considered a unitape instead of towpreg. ATP can typically apply material at a faster rate than AFP, but AFP can make more complicated shapes than ATP. Tailored Fiber Placement (TFP) is another way to name or brand AFP. Within this application, the term AFP encompasses conventional AFP, along with ATP and TFP.

Pultrusion: This is a process used to produce continuous fiber-reinforced polymers with a constant cross section. The process of pultrusion is illustrated in FIG. 10. Tows from the rovings of fiber reinforcements (77) are pulled and consolidated (78) and fed into a resin impregnation station (79), in which the fiber reinforcement is impregnated with a thermoset or thermoplastic resin (80). The resin-impregnated fiber is then pulled through a heated shaping die (81). If the FRP is thermoset based, the heated pultrusion die causes the resin to cure and solidify. If the FRP is thermoplastic based, the heated pultrusion die is used to fuse the different impregnated fiber tows together, and a cooling die (82) is used to solidify the FRP. The solidified FRP is then clamped and pulled out by pullers (83). The solidified FRP is then cut to the right length with saws at the cutoff station (84). The cutoff FRP parts (85) then fall into a catching station (86).

Roll Wrapping: This is a process in which layers of FRP laminates are wrapped on a mandrel (generally a steel mandrel) to create tubes. This process is illustrated in FIG. 11, in which the laminates (88, 89, 90, and 91) are being wrapped around the mandrel (87). Different orientations and types of laminates are roll wrapped. For example, a zero-degree laminate (88), a 45-degree laminate (89), a 90-degree laminate (90), and a woven laminate (91). Fibers oriented in the zero-degree direction provide axial bending and compressive strength, fibers oriented in the 45-degree direction provide torquing strength, and fibers oriented in the 90-degree direction provide crushing strength. The mandrel/laminate assembly is wrapped in plastic for compaction, heated, and cured. This process is commonly used to create a composite part with a reusable mandrel. However, in some embodiments, other FRP structures act as the “mandrel” and the wrapped laminates acts as additional support, strength, and permanent reinforcements to the wrapped FRP structure.

Filament Winding: This is a process in which tows of fiber (filaments) that are under tension are fed through resin and wound around a rotating mandrel (which is generally made of steel). This process is illustrated in FIG. 12, which illustrates filaments (92) being wound around the mandrel (93). The winding creates geometric patterns which optimize strength in specific orientations. Similar to roll wrapping, Fibers oriented in the zero-degree direction provide axial bending and compressive strength, fibers oriented in the 45-degree direction provide torquing strength, and fibers oriented in the 90-degree direction provide radial crushing strength. After winding, the mandrel/wound tow assembly is wrapped in a plastic wrap, heated, and cured. The plastic wrap contracts under heat, creating the necessary compaction in the part. The above process is commonly used to create a composite part, such that the mandrel is removed from the composite part and reused. In some embodiments, similar to roll wrapping, instead of using a removable/reusable steel mandrel, a composite part is used as the “mandrel”, and the filaments are permanent reinforcements that are stuck to the composite part, thereby using the filament winding provides additional support and strength to other FRP structures.

Creating a continuous FRP rod/tube: Continuous FRP rod/tubes are made from continuous fiber materials, and often have high strength and stiffness. Continuous FRP rods/tubes are typically created by pultrusion, roll wrapping, filament winding, or AFP. In addition, any one or combination of roll wrapping, filament winding, or AFP can be used to add continuous support on another part to create a continuous FRP rod/tube. Within this invention, every conceivable combination of these processes is considered within the term of creating a continuous FRP rod/tube.

Standard FRP Billet: A standard FRP billet can be manufactured from any combination of the following methods: compression molding, RTM, injection molding, vacuum bagging, hand laying up, autoclave manufacturing, pultrusion, AFP, roll wrapping, and filament winding. Supplementally, a combination of filament winding, AFP, and roll wrapping can be used to reinforce said billet. These methods are not limiting, and any reasonable method of manufacturing an FRP billet is included.

### General Manufacturing Process Definitions

Impregnation Sealing: Impregnation Sealing is a process that introduces an impregnant sealant, as a filling material, into the open pores of the material being treated. The process eliminates or greatly reduces the undesirable hygroscopic effects of porosity in the parts being treated. Examples of impregnant sealants include but are not limited to sodium silicate, tung oil, linseed oil, pitch gum, thermoplastics, thermosets, ISL-10C super, ISL-15C thin, IDL-500C medium, ISL-2500 thick, PC504/66, sinterseal, electroseal, Rexeal 100, and MX2. The general process is typically as follows: the parts are soaked in the impregnant sealant. This generally occurs in a vacuum or autoclave because the air can be evacuated from the porous holes so the voids can be better filled with the impregnant sealant. Next, the part is drained and/or cold washed with water, leaving the solution in the pores of the substrate. A combination of heat, washing, and vacuum solidifies the impregnant sealant in the pores, thereby pressure sealing the part. Depending on the type of process and materials used, more steps that include using a vacuum, water, heat, cold, and impregnant sealant, activator/catalyst may be included anywhere in the process.

Heavy Metal Ion Implantation (HMI): This is a process that bombards heavy metal ion particles, such as but not limited to Uranium, Molybdenum, Titanium, Tungsten, or Chromium, deep into the molecular structure of part surfaces. The process of HMII increases the microhardness of the surface and fatigue life of the part. In addition, the implantation treatment improves the surface finish/smoothness of the part being treated. The heavy metal ions are typically accelerated to about 400 miles per second before colliding with the part being treated. The process typically occurs in a vacuum of 1 billionth atmospheric pressure to prevent contamination from air molecules or any disruption of the path for the heavy metal ions to flow. Because the bombarding ions add energy to the substrate, and heat cannot dissipate well in vacuum, FRP parts being treated typically need a heat soak system to prevent the temperature of the part from rising above its glass transition temperature.

Vapor Deposited Coating: This is a process that applies high-performance solid material coatings onto a given substrate. The two main processes are Physical Vapor Deposition (PVD) and Chemical Vapor Deposition (CVD). In PVD, the material to be coated is vaporized and condensed into a thin film on the substrate being coated, either by sputtering or evaporation. In CVD, the substrate being coated is exposed to volatile precursors that react on the surface of the substrate to produce the desired deposit. The following list of coatings is exemplary only and not intended to be limiting. DLC (Diamond-Like Carbon) is a coating that consists of diamonds suspended in a graphite matrix. The coating has a hardness of about 1520 to about 2000 Hv and a coefficient of friction of 0.05-0.10. A higher concentration of diamonds increases both the hardness, but also increases the coefficient of friction. MoS2 (Molybdenum Disulfide) is a very thin anti-friction coating that reflects the hardness of the substrate underneath. The coating generally has a 0.01-0.03 coefficient of friction and is typically applied directly to the substrate or on a hard ceramic coating. TiN (Titanium Nitride), ZrN (Zirconium Nitride), CrN (Chromium Nitride), TiCN (Titanium Carbonotride), CrCN (Chromium Carbonotride), TiCrN (Titanium Chromium Nitride), AlTiN (Aluminum Titanium Nitride), and AlCrN (Aluminum Chromium Nitride) are hard technical ceramic coatings that have a hardness of over 2000 Hv. These coatings are generally followed by a coating of MoS2 because of their high coefficient of friction. Aluminum, brass, cadmium, chromium, copper, gold, iron, molybdenum, nickel, silver, titanium, and zinc are example metal coatings. These coatings are generally used to create a conductive surface that can be built up with electroplating.

Electroplating: This is a process that uses controlled electrolysis (using electric current to cause a non-spontaneous chemical reaction) to apply a desired metal coating from an anode to a cathode. Examples of metals that are electroplated include aluminum, brass, cadmium, chromium, copper, gold, iron, molybdenum, nickel, silver, titanium, and zinc. The anode is the metal part which is used to create the plating, and the cathode is the part being coated by the anode material. Both the anode and cathode are placed in a bath with electrolyte chemicals and are exposed to an electric charge. The electric charge causes anions (negatively charged ions) to move to the anode and cations (positively charged ions) to move to the cathode, which covers the cathode part in a metal coating. This creates a thin shell of metal on the cathode part. To electroplate non-conductive substrates, such as most FRP materials, the parts must first be made electrically conductive. This is typically achieved by adding a thin layer of metal through an electroless plating process, such as PVD coating. For the embodiments described herein, electroplating FRP material includes an optional initial step of electroless plating to manufacture a conductive surface as appropriate for adding an electroconductive layer.

Painted Coatings: These coatings include but are not limited to general plastic paints, ceramic paint coatings, metallized paint coatings, molybdenum paint coatings, molybdenum disulfide paint coatings, and graphite paint coatings. Cerakote coatings, which are high-performance ceramic based paint coatings, are also included in this definition. These painted coatings can be applied by spraying, dipping, and/or brushing. Painted coatings are generally used to protect the substrate from oxidization, to create a thermal barrier coating, to create an anti-friction surface, to create an anti-wear surface, and/or to create a UV or environmental protection coating.

Plasma Spray Coating: This is a process in which a substrate is sprayed with molten or semi-molten material to create a hard coating. The coatings are applied in a high temperature process in which the powdered coating material is heated through an extremely hot plasma flame (over 15,000° F.) and accelerated toward the substrate. The coating material then cools and forms a hard coating. Plasma spray coatings are generally used to protect the substrate from oxidization, to create a thermal barrier coating, to create an anti-friction surface, and/or to create an anti-wear surface. Generally, for plasma spray coating FRP materials, the materials are pre-coated with a bond coat such as nickel-aluminide. The bond material provides a more conductive and harder surface which enables bonding with a secondary coat. For embodiments described herein, plasma spray coating FRP material includes an optional initial step of applying a bond coat to manufacture a conductive and harder surface as appropriate for adding a conductive surface.

Dry Film Coatings: These coatings create anti-friction surfaces that maintain a low coefficient of friction even under dry conditions (without liquids or oils). Molybdenum Disulfide (MoS2), Tungsten Disulfide (WS2), and Graphite are common dry film coatings. Dry film coatings are typically applied by brushing, spraying, or dipping, in which the dry film coating material (MoS2, WS2, or Graphite) is added to resins and binders that are then coated on the part. These resins and binders typically require either a thermal, chemical, or air cure. Dry film coatings are also applied by impingement coating, in which the coating is applied in an extremely thin layer and does not require a cure.

Machining: This encompasses all processes and all conceivable combinations of processes that remove significant amounts of material by using machines, including but not limited to milling, grinding, and turning. Milling removes material by moving a high-speed rotating tool into a part. Milling can be used to make parts with more complex geometry. Grinding removes material by rotating a high-speed grinding wheel, much larger than a milling tool, into a part, resulting in a high precision part with a smooth surface finish. Turning removes material by moving a cutting tool into a rotating part, resulting in high precision and rotationally symmetric parts.

Finishing: This encompasses all processes and all conceivable combinations of processes that remove relatively small amounts of material to increase smoothness of a surface and/or bring dimensions into tight tolerances. Finishing includes but is not limited to honing, lapping, polishing, vibratory finishing, electropolishing, finish milling, finish grinding, and finish turning. Honing is used to improve dimensional accuracy and surface finish on circular holes. Lapping is used to enhance the surface finish, typically on flat, circular, and spherical faces that do not require an isotropic finish. Vibratory finishing and electropolishing are used to enhance the surface finish on parts with complex geometries that require an isotropic finish. Finish milling, finish grinding, and finish turning refers to using any of these processes to bring dimensions into tight tolerances or create a better surface finish on parts—by removing less material and have a slower feed rate, these processes can achieve better tolerances/finishes than when roughing (where a lot more material is removed quickly).

### Blade Definitions

For purposes of this application, the term “blades” is defined to also include vanes and equivalent structures.

FIG. 13A and FIG. 13B contain different standard parts of a blade. The integral parts of a blade include the leading edge (95), the trailing edge (96), the squealer tip (97), the pressure side (98), the suction side (99), the platform (100), and the root section (101). The leading edge, trailing edge, squealer tip, pressure side, and suction side make up the airfoil portion (94) of the blade. FIG. 13A also contains the different directions relative to the blade, including the axial direction (102), the radial direction (103), and the circumferential direction (104).

The leading edge (95) is the edge of the blade that first interacts with the airflow. The shape of the leading edge is critical in the performance and efficiency of the rotor. The leading edge also experiences the most wear because it directly contacts the air and any particulates. Failure of the blade can be caused by micro-cracks in the leading edge that become larger over time. Because of this, FRP blade leading edges are typically made from other materials (like metals) that have superior abrasion and wear resistance, and the leading edges are often polished to remove any micro-cracks.

The trailing edge (96) is the edge opposite of the leading edge on the blade. The profile of the trailing edge is critical because it dictates how the air will enter the next stage. However, the trailing edge does not experience as much wear from particles as the leading edge.

The squealer tip (97) is the edge at the end of the airfoil. A tight clearance is required between the squealer tip and the compressor case so that minimal air passes outside the tip of the blade. Therefore, the tolerance for the length of the blade must be very tight. The squealer tip is sometimes made thinner than the rest of the airfoil, allowing it to wear away without damaging the blade in the case of interference.

The pressure side (98) is the face of the blade airfoil that interacts directly with the airflow. The surface finish and contour of the pressure side are critical features that impact airflow and, consequently, power and fuel efficiency.

The suction side (99) is the face of the blade airfoil opposite of the pressure side (98). The shape of the suction side determines how the airflow behaves behind the blade. Therefore, the surface finish and contour of the suction side are also critical features.

The platform (100) is the area above the root that extends into the airfoil. The platform often acts as an air seal with platforms of adjacent blades, mitigating airflow past the blade. The platform also has a fillet in the transition to the airfoil that is necessary to avoid concentrating stress in the transition.

The directions of the blades are based on the circular motion that the blades spin. Essentially, the axial direction (102), radial direction (103), and circumferential direction (104) would all be their respective directions for the rotor/shaft of the gas turbine. Therefore, the axial direction (102) would go lengthwise along the root (101), the radial direction (103) would go lengthwise along the airfoil (94), and the circumferential direction (104) would go widthwise along the root (101).

The root section (101) is the area that is mounted on the rotor or casing. Depending on the application, the root section has a specific shape. FIG. 14A, FIG. 14B, FIG. 14C, FIG. 14D, and FIG. 15E show examples of root sections that are used on blades. Typically, a fir tree (105) is used for turbine blades, a dovetail (106) is used for fan and compressor blades, a slotted platform (107) is used for stator vanes, a pivot mount (108) is used for variable guide vanes, and a bolted mount (109) is used for helicopter blades. These are some examples of root section designs, but they are not limiting, and the root section can be any shape that is suitable for the application.

Blades are airfoil structures that are part of a rotating assembly, typically mounted to a rotor. Vanes are airfoil structures that are stationary, typically mounted to the inside of a case. Some vanes, such as inlet or outlet guide vanes, are mounted on a rotating pivot that allows for control of the airfoil, which can be used to adapt the air flow to different operating speeds and conditions. In this disclosure, it is understood that the term blades encompasses both blades and vanes, as well as any other airfoil structure (such as but not limited to helicopter blades).

### FRP and Chopped FRP in Blades

Using FRP in blades is beneficial because it results in quicker acceleration, reduced fuel consumption, reduced emissions, increased efficiency, increased safety, less wear on other components, and reduced harmonic forces.

FRP blades can have the same strength and stiffness as metal blades, while having significantly less weight. By having less mass, FRP blades require much less energy to accelerate. This results in a reduction of spent fuel, decreasing fuel costs and greenhouse gas emissions. For the same acceleration of a blade of lower mass, less force is required, and this puts less force and stress on supporting parts, such as the rotor housing. FRP blades are also safer during failure because they carry less momentum, resulting in less damage and a higher factor of safety for containment structures. By using FRP blades, less mass is proportionally in the blades and more mass is in the rotor housing. Therefore, when an FRP blade breaks, the rotating assembly becomes less unbalanced compared to when a metal blade breaks, further increasing safety. Furthermore, because FRP material has a different resonance frequency than metal and typically is a harmonic dampener, FRP blades mitigate harmful harmonic vibration stresses, which are also casually known as the “ting” experienced in a metal-only assembly.

Using chopped FRP blades is beneficial in comparison to using traditionally manufactured FRP blades because chopped FRP blades are easier to mass manufacture, have less interlaminar shear issues, have near isotropic properties, and can be manufactured with more extreme profiles and curvatures.

The fibers in chopped FRP are oriented randomly to achieve the best consistency and most isotropic properties. Because of this, chopped FRP blades do not require precise layups of FRP fabric laminates, making them easier, cheaper, and less labor intensive to mass manufacture. Since the fibers are oriented randomly, chopped FRP blades have reinforcing fibers in every direction, mitigating the interlaminar shear issues that are experienced with traditional continuous FRP laminate layups. This also results in near isotropic properties, allowing the chopped FRP blades to handle loads from multiple directions with similar strength and stiffness properties. Furthermore, because chopped fibers are significantly smaller than fibers typically used in continuous FRP manufacturing, the chopped fibers can fit into tight curvatures and contours, reinforcing the polymer in those areas. With continuous laminates, in areas with tight curvatures and contours, the polymer is either not reinforced at all by fibers, or reinforced with fibers that are wrinkled, which have significantly weaker mechanical properties. This benefit of chopped FRP is important for manufacturing blades, especially in areas like the root that require dramatic curvature and thickness changes.

Although using chopped FRP in blades has multiple benefits, using only chopped FRP for blades can result in lower mechanical properties when compared to making the blade from continuous FRP laminates. This is because the fibers are short and cannot reinforce the entire structure. Pure chopped FRP blades would typically be only used in applications that are not as structurally demanding, such as stator vanes. Considering this disadvantage, this disclosure covers many ways to create blades that are stronger than pure chopped FRP blades while still maintaining the benefits of chopped FRP.

Chopped FRP can be used for any type of blade. Chopped FRP can be used to make helicopter blades. FIG. 15 illustrates a gas turbine engine and contains blades that can be made from chopped FRP, including: fan blades (117), variable guide vanes (118), compressor rotor blades (119), compressor stator vanes (120), turbine rotor blades (121), and turbine stator vanes (122). Generally, in a gas turbine engine used for thrust, the fan blades (117) suck in air. Some of the air becomes bypass air that provides thrust and the rest of it is guided by the inlet guide vanes (118) into the compressor sections (111 and 112). The compressor blades (119) and vanes (120) compress the air before the air is combusted in the combustion section (113). After combustion, the air performs work on the turbine blades (121) in the turbine sections (114, 115, and 116) to generate power for the fan section (110) and compressor sections (111 and 112). Typically, gas turbine engines can have any number of low-pressure, intermediate-pressure, and high-pressure stages in the compression sections (111 and 112) and turbine sections (114, 115, and 116). Any of the blades and vanes in these sections can be made from chopped FRP. These examples are not to be understood as limiting in the applications of chopped FRP blades.

### Chopped FRP Blade Composition

The present invention includes any FRP blade that uses chopped FRP. More specifically, it covers any blade that is at least 40% FRP by volume, in which the FRP is at least 10% chopped FRP by volume. Typically, the FRP blade is at least 70% FRP by volume so the weight-saving properties of FRP can be significantly taken advantage of. Typically, the FRP portion of the blade is at least 40% chopped FRP, since using less than 40% chopped FRP increases the risk that there is not enough chopped material between the fabric and/or windings, which could result in poor interlaminar shear strength.

This application covers using any polymer matrix and using any fiber. However, typically the FRP material would be made from an organic polymer matrix with a glass transition temperature of 200-1,000 F and the FRP would have a density between 1.1 g/cm3 to 2.4 g/cm3. In most cases, organic polymer matrix materials will be used because they are stronger, less brittle, and less expensive than inorganic polymers. Inorganic polymers would only be used when temperatures are too high for organic polymers, which would only happen in the last stages of the HP compressor section or in the turbine section of gas turbines. Otherwise, organic polymers are better suited than inorganic polymers for a vast majority of blade applications. Organic polymers used for FRP typically have a Tg of at least 200 F, with a 1000 F Tg maximum on the extreme high-end. The density of the FRP would typically range from 1.1 g/cm3, which is the lower bound for carbon fiber reinforced polymers, to 2.4 g/cm3, which is the upper bound for fiberglass reinforced polymers. Fiberglass has a higher density than carbon fiber, and when using an organic polymer, the density of the polymer matrix is typically less than that of the fiber reinforcement. Therefore, a 1.1 g/cm3 carbon fiber reinforced polymer would have a very low fiber-resin ratio, and a 2.4 g/cm3 fiberglass reinforced polymer would have a very high fiber-resin ratio.

For many applications, continuous FRP combined with the chopped FRP is necessary to achieve the desired strength and stiffness. The continuous FRP consists of continuous wound FRP and/or continuous FRP fabric. To include continuous FRP, the continuous FRP is typically molded with the chopped FRP with compression molding, resin transfer molding, injection molding, or any of their variants (as described in the definitions).

Typically, at least 10% of the overall FRP must be continuous FRP to have negligible strength/stiffness increases. However, the manufacturer will typically make the continuous FRP be 30-80% of the overall FRP as the manufacturer tries to fit as much continuous FRP as possible to achieve maximum mechanical properties. Typically, it is always possible to fit at least 30% continuous FRP but getting above 80% continuous FRP is difficult. This is because, for continuous wound FRP, there needs to be enough chopped FRP to flow between the gaps in the continuous winding. In addition, with both continuous wound FRP and FRP fabric, too much continuous FRP leads to fiber wrinkling and breaking during the molding process as there is not enough chopped FRP to act as a cushion material during the molding process.

If using continuous wound FRP, the continuous wound FRP will typically have a tensile modulus of 15-85 msi and a tensile strength of 142-600 ksi in the unidirectional fiber orientation. The continuous wound FRP will oftentimes have carbon fiber reinforcement, and this property range covers the mechanical properties for using the different types of carbon fiber towpreg (standard modulus, intermediate modulus, high modulus, and ultra-high modulus carbon fiber towpreg). 15 msi would be the lowest modulus when using standard modulus carbon fibers, while 85 msi would be the highest modulus when using ultra-high modulus carbon fibers. 142 ksi would be the lowest strength when using ultra-high modulus carbon fibers (as the stiffest carbon fibers are typically not as strong), while 600 ksi would be the highest strength when using intermediate modulus carbon fibers (as the strongest fibers typically lie in the intermediate modulus range, stiffer than standard modulus carbon fibers but less stiff than high modulus carbon fibers).

When using continuous FRP, the chopped FRP part of the FRP section of the blade will typically have an average fiber length (AFL) of 0″-1″. 1″ is the standard size for most chopped FRP materials (such as BMCs, SMCs, and TMCs). However, when making a part without continuous wound FRP, typically longer chopped FRP will be used for higher mechanical properties, with a typical AFL of 1.5″-3″. However, in this specific embodiment, when using continuous wound FRP, you want the continuous wound FRP to take up the load and the chopped FRP to be more isotropic. Therefore, the AFL would be 1″ or less. This is because chopped FRP with a lower AFL can fill gaps more easily and resist interlaminar shear well because shorter fibers have less of a tendency to align flat to the mold direction.

### Chopped FRP Blade Construction

In the present invention, a chopped FRP blade is made from any number of parts. These parts may be composed of any different types of FRP, metal, technical ceramic, or plastic. The parts may be assembled using any type and any number of adhesives, undercuts, dowel pins, and/or fasteners. Below are exemplary methods of construction for chopped FRP blades.

The assembly shown in FIG. 16A, FIG. 16B, and FIG. 16C uses an airfoil (123) that slides into the root (124) radially with optional dowel pins (125) added.

The assembly shown in FIG. 17A, FIG. 17B, and FIG. 17C uses an airfoil (126) that slides into the root (127) axially with an optional bend-type undercut (128). Sliding the parts together allows for greater surface area for adhesive, potential undercuts, and/or structural support. Undercuts increase the structural support in directions that are not on the sliding axis by transforming forces that normally act upon the adhesive into forces that act upon the FRP. A bend-type undercut is beneficial because it maintains constant thickness, so if continuous laminates are used in the air profile section, it is easier for the laminates to extend from the airfoil into the root section of the blade.

The assembly shown in FIG. 18A, FIG. 18B, and FIG. 18C uses a split root pair (129) that closes in on the airfoil section with a wedge undercut (132). Dowel pins (130) and fasteners (131) secure the split root pair (129) together. Using a split root pair (129) allows the assembly to have an undercut that is easy to manufacture. The wedge undercut (132) maintains constant thickness with the same benefits as a bend-type undercut.

The assembly shown in FIG. 19A, FIG. 19B, and FIG. 19C uses an initial airfoil part (133) with the root (134) molded around it. Molding parts into one another adds structural support to the assembly.

The methods of assembly shown are only examples and not to be understood as limiting in any sense. The present invention covers any combination of the methods shown above and any other suitable assembly methods that result in a blade that is at least 40%/FRP by volume and of which the FRP is at least 10% chopped FRP by volume.

### Chopped FRP Blade Manufacturing

An FRP blade or part of a blade is manufactured with compression molding. FIG. 20A, FIG. 20B, and FIG. 20C show the standard compression molding process for said part. In the first stage as shown in FIG. 20A, the molded part is compression molded from chopped fiber molding compound (135) that is placed between the cavity (138) and the core (139). A layup jig is optionally used to prepare the molding shot before placing it in the mold. In the second stage as shown in FIG. 20B, the part (141) is molded under high pressure. After curing, the part is ejected by the ejector pins (144). The final part (145) is shown in FIG. 20C.

Optionally, any number or amount of FRP windings (136) and/or FRP fabric laminates (137) are used with the chopped fiber molding compound (135) to add directional reinforcement to the molded blade or part of a blade. In some applications, chopped FRP materials alone are not enough to withstand the forces experienced by a blade, in which case FRP windings and FRP fabric laminates are necessary. In some applications, the use of FRP windings and FRP fabric laminates can increase the strength-to-weight ratio of the blade, allowing manufacturers to reduce the volume and weight of the blade while maintaining the same strength. If FRP windings and/or FRP laminates are used, the high cavity pressures result in strong adhesion and bonding between the different materials being molded.

In an alternative embodiment, an FRP blade or part of a blade is manufactured with resin transfer molding. FIG. 21A, FIG. 21B, and FIG. 21C show the standard molding process for said part. In the first stage as shown in FIG. 21A, the molded part is resin transfer molded from chopped fiber material (146) that is placed between the cavity (149) and the core (150). A layup jig is optionally used to prepare the molding shot before placing it in the mold. In the second stage as shown in FIG. 21B, resin is injected from the resin injector (157), filling the part and impregnating the fibers. Excess resin flows out of the vents (158). After curing, the part is ejected by the ejector pins (159). The final part (160) is shown in FIG. 21C.

Optionally, any number or amount of FRP windings (147) and/or FRP fabric fibers (148) are used with the chopped fiber material (146) to add directional reinforcement to the molded blade or part of a blade.

In an alternative embodiment, an FRP blade or part of a blade is manufactured with injection molding. FIG. 22A, FIG. 22B, and FIG. 22C show the standard molding process for said blade. In the first stage as shown in FIG. 22A, the molded part is injection molded from chopped fiber material (161) that is placed between the cavity (164) and the core (165). A layup jig is optionally used to prepare the molding shot before placing it in the mold. In the second stage as shown in FIG. 22B, resin is injected from the sprue (171), filling the part. After curing, the part is ejected by the ejector pins (172). The final part (173) is shown in FIG. 22C.

Optionally, any number or amount of FRP windings (162) and/or FRP fabric fibers (163) are used with the chopped fiber material (161) to add directional reinforcement to the molded blade or part of a blade.

With both resin transfer molding and injection molding, the chopped fiber material (146 and 161), the windings (147 and 162), and/or the FRP fabric fibers (148 and 163) can be inserted dry or impregnated with resin, depending on manufacturing preference for them to be pre-impregnated or get impregnated by the polymer being transferred/injected.

In an alternative embodiment, an FRP blade or part of a blade is manufactured by machining a standard FRP billet into the blade or part of a blade.

### Secondary Manufacturing Processes

After manufacturing the blade or parts of the blade through any of the previously mentioned primary processes, optional secondary processes are performed on any of the parts in any order, including the assembly of any number of parts of a blade.

Any number of critical areas of the blade are optionally machined and/or finished. Critical areas include but are not limited to the root section, leading edge, trailing edge, squealer tip, pressure side, suction side, and platform.

FRP fabric laminates are optionally added on the exterior of the blade or part of the blade. As shown in FIG. 23, the fabric laminates can be pre-cured plates (176) that are attached directly to the blade or part of the blade (174). The fabric laminates can also be uncured fabric layers (175) that are wrapped around the blade or part of the blade (174) and cured. The fabric laminates can be made from any FRP material. In an embodiment of this invention, the fabric laminates are made from a material with higher impact and/or abrasion resistance than the underlying material to increase shock and/or wear resistance.

Filament winding or AFP is optionally used to reinforce any section of the blade or part of the blade. FIG. 24A and FIG. 24B shows the filament winding process and AFP process on a blade. The benefits of filament winding include being significantly faster and less expensive than AFP. The benefit of AFP is that accuracy and consistency in positioning and fiber orientation is increased. This results in parts that can have better material properties and consistency. AFP would typically be used on select faces of the airfoil, while filament winding would wrap around the entire airfoil.

Continuous FRP rods and/or tubes (183 and 184) are optionally added in any position and orientation as reinforcement to the blade or part of the blade (182), as shown in FIG. 25A, FIG. 25B, and FIG. 25C. Rods and/or tubes will often be added in blades that do not have continuous wound fiber to increase stiffness and/or strength properties. Typically, rods and/or tubes are added in the radial direction (184) to support the airfoil. Rods and/or tubes can also be added to reduce the amount of weight in the blade and/or create supported cooling channels. Typically, to add a rod or tube to the blade or part of the blade, a hole is machined and potentially finished, such as with honing, before bonding in the rod or tube with an adhesive. However, this process is not limiting, and any suitable method of adding a tube or rod can be used.

One or more sheaths, made from metal, technical ceramic, or FRP, are optionally added to the blade or part of the blade. A sheath can be added anywhere on the blade, although typically the sheath is added at the root section, leading edge, trailing edge, squealer tip, pressure side, suction side, or platform. FIG. 26A, FIG. 26B, FIG. 27A, and FIG. 27B show different ways that the sheath can be attached to the blade or part of the blade, using a root section sheath as an example. The sheath can be attached with any combination of optional undercuts (185), optional adhesives, and optional dowel pins (186 and 187). The examples shown in the figure are not limiting, and any reasonable method of attaching the sheath to the blade or part of the blade is covered.

In one embodiment of this invention, a layer of elastomer, such as but not limited to rubber or silicone, is attached between the sheath and the blade. The elastomer layer provides the FRP with shock absorbance, increasing the impact resistance of the blade. FIG. 28 shows an example of an elastomer layer (188) between a leading-edge sheath (190) and the main FRP body of the blade (189). The elastomer layer can be used at any location of the blade in which a sheath is used. The elastomer layer can be attached to the blade with optional undercuts, optional adhesive, optional dowel pins, and/or with any other conceivable method of attachment.

Any number of elastomer pieces are optionally added anywhere on the outside surface of the blade. Typically, the elastomer is added to the leading edge, pressure side, and/or the root section. FIG. 29 shows an example of an elastomer piece on the leading edge surface (192) and an elastomer piece on the root surface (193) of a blade (191). The elastomer piece on the leading edge and pressure side can typically handle small particle collisions and large impacts better than FRP can, increasing the abrasion and impact resistance. The elastomer on the root section interacts with the rotor or stator and can typically absorb impact shocks better than FRP can, increasing impact resistance.

One or more coatings are optionally applied to the blade or part of the blade. One such coating is a vapor deposited coating, which is optionally applied to the blade or part of the blade. A plasma spray coating could also be applied to the blade or part of the blade. Electroplating could also be applied to the blade or part of the blade. A painted coating could also be optionally applied to the blade or part of the blade. A dry film coating could also be optionally applied to the blade or part of the blade. These coatings have been explained in the definition section, and they can be used to protect the blade or part of the blade from oxidation or corrosion, create a smooth surface finish, create an anti-wear surface, or act as a thermal barrier coating. These examples are not to be taken as limiting in any sense, and any reasonable use of coatings or combination of coatings on the blade or part of the blade is covered within this disclosure.

Heavy metal ion implantation (HMII) treatment is optionally applied to the blade or part of the blade. HMII treatment has been explained in the definition section, and typically occurs after machining. HMII treatment that occurs before coatings enhances the mechanical properties of the part, including the stiffness, strength, and fatigue properties. HMII treatment that occurs after coatings enhances the properties and benefits of the coatings, including microhardness and wear resistance. HMII treatment that occurs after polishing enhances the surface finish of the part.

Impregnation sealing treatment is optionally applied to the blade or part of the blade. Impregnation sealing prevents the FRP material from absorbing fluid (such as water). This is important because the absorbing of fluid increases the weight of the part, throwing the rotor off balance, and degrades the structural integrity of the FRP. Impregnation sealing is typically the last step because outgassing may occur if parts are subjected to HMII after impregnation sealing. In addition, impregnation sealing typically occurs after all machining is completed and all coatings are applied to seal the outside surfaces that are exposed to fluids.

Shot peening is optionally applied to the blade or part of the blade. Shot peening typically is applied to the metal areas of the blade, increasing the mechanical properties of the metal, which includes fatigue properties and wear resistance.

The instant invention has been shown and described in what are the most practical and preferred method steps. It is recognized, however, that departures may be made within the scope of the invention and that modifications will occur to a person skilled in the art. With respect to the above description then, it is to be realized that the optimum dimensional relationships for the parts of the invention, to include variations in size, materials, shape, form, function, steps, and manner of operation, assembly, and use, would be apparent to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact constructions and operations shown and described, and accordingly, all suitable modifications and equivalents may be resorted to falling within the scope of the invention.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean+/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

1. A fiber-reinforced polymer blade comprising:
a blade having at least a portion of itself including fiber-reinforced polymer, a fiber-reinforced polymer portion of the blade including chopped fiber-reinforced polymer and continuous fiber-reinforced polymer.

2. (canceled)

3. (canceled)

4. (canceled)

5. The fiber-reinforced polymer blade of claim 1, wherein at least 40% of the fiber-reinforced polymer portion of the blade by volume is chopped fiber-reinforced polymer.

6. The fiber-reinforced polymer blade of claim 1, wherein the blade is a helicopter blade, a fan blade, a compressor blade, or a turbine blade.

7. (canceled)

8. (canceled)

9. (canceled)

10. (canceled)

11. (canceled)

12. (canceled)

13. The fiber-reinforced polymer blade of claim 1, wherein at least 30% of the fiber-reinforced polymer by volume is continuous fiber-reinforced polymer.

14. (canceled)

15. (canceled)

16. The fiber-reinforced polymer blade of claim 1, wherein the blade is selected from the group consisting of: a contour compression molded part, a resin transfer molded part, a high pressure resin transfer molded part, a vacuum assisted resin transfer molded part, an injection molded part, an over mold injection molded part, a resin injection molded part, or a machined/finished standard FRP billet.

17. The fiber-reinforced polymer blade of claim 1, wherein the blade comprises at least one area that has been machined or finished.

18. The fiber-reinforced polymer blade of claim 1, further comprising fiber-reinforced polymer fabric layers added on an airfoil profile, a root section, or both.

19. The fiber-reinforced polymer blade of claim 18, wherein the fabric layers are made of a material with a greater impact strength than that of the remaining blade material.

20. The fiber-reinforced polymer blade of claim 1, further comprising an added fiber-reinforced polymer layer on an airfoil profile, wherein the added fiber-reinforced polymer layer is made by automated fiber placement.

21. The fiber-reinforced polymer blade of claim 19, wherein the fibers that compose the fabric layers have a greater impact strength than that of the fibers that compose the remaining fiber-reinforced polymer blade material.

22. The fiber-reinforced polymer blade of claim 1, wherein the blade is a vane.

23. The fiber-reinforced polymer blade of claim 1, wherein a portion of the fiber-reinforced polymer portion of the blade is manufactured by co-molding continuous fiber-reinforced polymer with chopped fiber-reinforced polymer.

24. The fiber-reinforced polymer blade of claim 23, wherein a portion of the co-molded continuous fiber-reinforced polymer is continuous wound fiber-reinforced polymer.

25. The fiber-reinforced polymer blade of claim 24, wherein a portion of the continuous wound fiber-reinforced polymer is wound around an external apparatus prior to being co-molded with chopped fiber-reinforced polymer.

26. The fiber-reinforced polymer blade of claim 23, wherein a portion of the co-molded continuous fiber-reinforced polymer is fiber-reinforced polymer fabric.

27. The fiber-reinforced polymer blade of claim 1, wherein a portion of the fiber-reinforced polymer portion of the blade comprises continuous fiber-reinforced polymer mixed into chopped fiber-reinforced polymer.

28. A fiber-reinforced polymer blade, wherein the blade is a vane, comprising:
a vane having at least a portion of itself including fiber-reinforced polymer, a portion of the fiber-reinforced polymer including chopped fiber-reinforced polymer.

29. The fiber-reinforced polymer vane of claim 28, wherein the vane is an independent part from a non-rotating stator case that gets mounted to the inside of the stator case.

30. The fiber-reinforced polymer vane of claim 28, wherein the vane is an inlet guide vane, an outlet guide vane, or a variable guide vane that is attached with a pivot mount.
